(19) United States
(12) Patent Application Publication
(10) Pub. No.: US 2018/0341770 A1
(43) Pub. Date: Nov. 29, 2018

(54) ANOMALY DETECTION METHOD AND ANOMALY DETECTION APPARATUS

(71) Applicant: FUJITSU LIMITED, Kawasaki-shi (JP)

(72) Inventor: Soya Aoyama, Fuchu (JP)

(73) Assignee: FUJITSU LIMITED, Kawasaki-shi (JP)

(21) Appl. No.: 15/981,073

(22) Filed: May 16, 2018

(30) Foreign Application Priority Data
May 29, 2017 (JP) 2017-105950

(51) Int. Cl. G06F 21/55; G06F 21/56

(52) U.S. Cl. CPC G06F 21/554; G06F 2221/033; G06F 21/566

(57) ABSTRACT

An anomaly detection method includes, obtaining information indicating a parent-child relationship of a process, specifying a first name of a first parent process of the process and a second name of a second parent process of the first parent process on the basis of the information, determining whether each of the first name of the first parent process and the second name of the second parent process includes specific name, and outputting anomaly information in accordance with a result of the determining.

### CROSS-REFERENCE TO RELATED APPLICATION

This application is based upon and claims the benefit of priority of the prior Japanese Patent Application No. 2017-105950, filed on May 29, 2017, the entire contents of which are incorporated herein by reference.

### FIELD

The embodiments discussed herein are related to anomaly detection techniques.

### BACKGROUND

To date, there have been methods for detecting an anomaly, caused by malware, such as computer viruses, worms, and spyware, that illegally infects devices over networks. Concerning this anomaly detection, antivirus software using pattern matching that uses virus definition databases is known. There is also known a technique that, when a process is run and a specific function is called, suspends running of the process by hooking and detects a malicious behavior by analyzing call stack return address information. A related technique is disclosed in, for example, Japanese Laid-open Patent Publication No. 2015-141718.

### SUMMARY

According to an aspect of the invention, an anomaly detection method includes, obtaining information indicating a parent-child relationship of a process, specifying a first name of a first parent process of the process and a second name of a second parent process of the first parent process on the basis of the information, determining whether each of the first name of the first parent process and the second name of the second parent process includes specific name, and outputting anomaly information in accordance with a result of the determining.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of a functional configuration of an information processing apparatus according to an embodiment;

FIGS. 2A, 2B, and 2C are illustrative diagrams illustrating process trees;

FIG. 3 is an illustrative diagram depicting an example of a process database;

FIG. 4 is a flowchart illustrating an example of operations of an information processing apparatus according to an embodiment; and

FIG. 5 is a block diagram illustrating an example of a hardware configuration of an information processing apparatus according an embodiment.

### DESCRIPTION OF EMBODIMENTS

With the existing techniques, a problem arises in that it is difficult to detect an anomaly caused by unknown malware. For example, one attack approach that causes malware or the like to be undetectably downloaded and causes the downloaded malware to be executed is a drive-by download. In this drive-by download, malware is undetectably downloaded and is executed by exploiting the vulnerabilities in a standard browser of an operating system (OS), such as Windows (registered trademark), or in a plug-in of the browser. Therefore, malware that is downloaded varies widely, including strains derived from the original strain, and, in some cases, includes unknown malware that is not included in virus definition data bases.

Hereinafter, an anomaly detection program, an anomaly detection method, and an information processing apparatus according to embodiments will be described with reference to the accompanying drawings. Configurations having the same functions in the embodiments are given the same reference numerals and overlapping description is omitted. Note that an anomaly detection program, an anomaly detection method, and an information processing apparatus described in the embodiments given herein below are merely illustrative and are not intended to limit embodiments. In addition, the embodiments given herein below may be appropriately combined to the extent not inconsistent with each other.

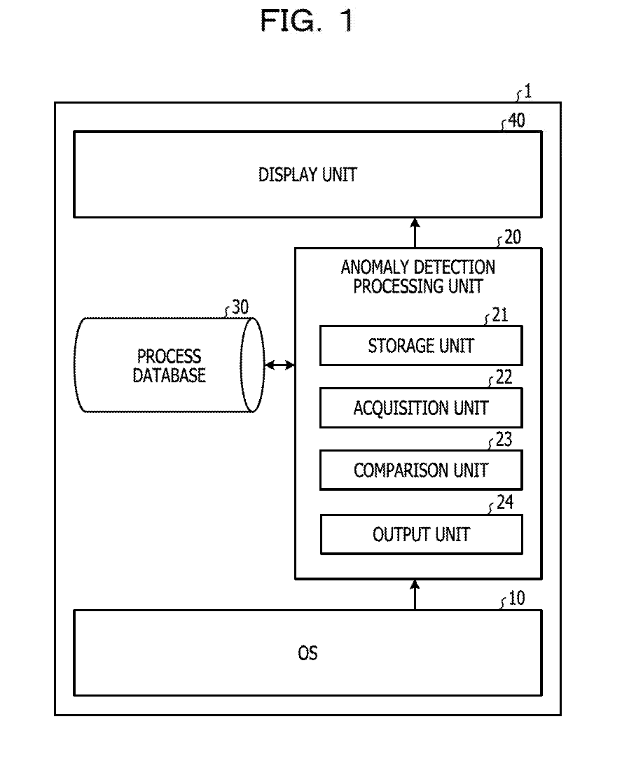

FIG. 1 is a block diagram illustrating an example of a functional configuration of an information processing apparatus according to an embodiment. An information processing apparatus 1 according to the embodiment is, for example, a computer such as a personal computer (PC) or a tablet terminal. As illustrated in FIG. 1, the information processing apparatus 1 includes an OS 10, an anomaly detection processing unit 20, a process database 30, and a display unit 40.

The information processing apparatus 1 executes an anomaly detection program in an execution environment of the OS 10 to thereby achieve the functions as the anomaly detection processing unit 20. The anomaly detection processing unit 20 performs anomaly detection processing that detects an anomaly caused by threatening malware, such as computer viruses, worms, and spyware, that illegally infects devices, and outputs an alert.

Specifically, instead of performing malware detection of a pattern matching type that makes use of virus definition databases and the like, the anomaly detection processing unit 20 monitors processes with application programs and the like and detects various anomaly events that occur when malware operates, thereby detecting malware.

The OS 10, such as Windows (registered trademark), provides processes associated with execution of a program with process identifiers (ID) identifying the processes so as to manage creation, running, and termination of each process. Some of the processes managed by the OS 10, such as a process newly created from a process that functions as the creation source (parent process), have a parent-child relationship between processes. For example, for a browser that displays a plurality of web pages within a single window by using a plurality of tabs, or the like, the process associated with each tab is managed as having a parent-child relationship with the process of the browser, assuming the process of the browser as the parent process.

A drive-by download, which is one attack approach that causes malware or the like to be undetectably downloaded and causes the downloaded malware to be executed, very often exploits the vulnerabilities of a standard browser and its plug-ins of the OS 10. In such an attack that exploits the vulnerabilities of a browser and its plug-ins, a process created by the attack has a parent-child relationship with the process of the browser. In a process tree representing a parent-child relationship of processes, a distinctive event, which is different from that in a normal process tree of a browser using a plurality of tabs, is represented in some cases.

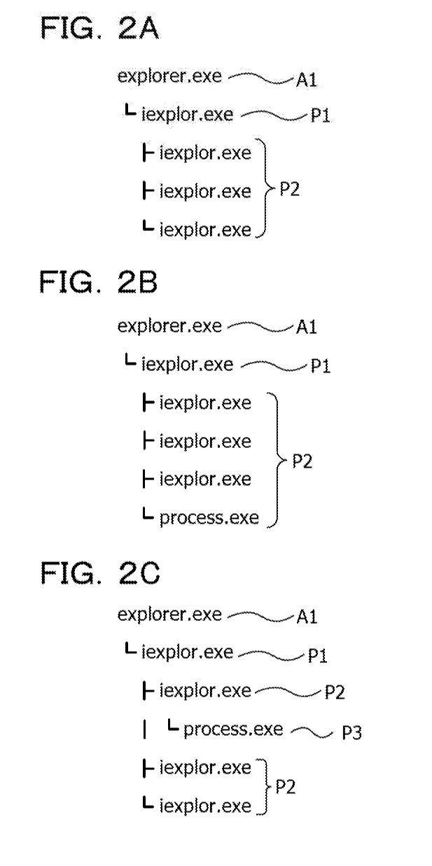

FIGS. 2A, 2B, and 2C are illustrative diagrams illustrating process trees. When Internet Explorer (registered trademark), which is a standard browser of Windows (registered trademark), is executed, a process tree as indicated in FIG. 2A is provided. Specifically, processes P2 corresponding to the opened tabs of the browser are created for one process P1 (parent process) corresponding to application A1. In addition, both of the names of process P1 and process P2 are “iexplor.exe”.

In addition, when a file on a website is downloaded and processed in Internet Explorer, the process tree is as indicated in FIG. 2B. Specifically, for one process P1 (parent process) corresponding to application A1, process P2 of downloading is created on the same level as processes 2 of the tabs. Note that the name of the process of downloading in process P2 is, for example, “process.exe”, a different name from “iexplor.exe”.

In contrast, when malware is downloaded into Internet Explorer, such that Internet Explorer is under the control of the attacker, and a new process is launched from the malware, the process tree is modified as indicated in FIG. 2C. Specifically, by using, as the parent process, process P2 generated in accordance with a tab from process P1 corresponding to application A1, process P3 of malware is generated. That is, the parent process to process P3 of malware is process P2, and the parent process of the parent process of process P3 is process P1. Therefore, both of the name of the parent process to process P3 of malware and the name of the parent process of the parent process of process P3 are “iexplor.exe” corresponding to the browser.

In such a manner, the process tree in the case where new process P3 is launched from malware indicates a distinctive event, which is different from those in the process trees indicated in FIGS. 2A and 2B. Note that although the case where the browser is Internet Explorer is illustrated in the above example, the same applies to the case of chrome (registered trademark) or the like. For example, when malware is downloaded to chrome, such that chrome is under the control of the attacker, both of the name of the parent process to process P3 of malware and the name of the parent process of the parent process of process P3 are “chrome.exe” corresponding to the browser.

Accordingly, the anomaly detection processing unit 20 detects malware by detecting a distinctive event (anomaly) in the process tree when new process P3 is launched from the malware. Specifically, the anomaly detection processing unit 20 outputs an anomaly when both of the name of the parent process of a predetermined process and the name of the parent process of the parent process of the predetermined process are a predetermined name such as “iexplor.exe”. Such malware detection enables the information processing apparatus 1 to detect even unknown malware that is yet to be registered in virus definition databases and the like.

The anomaly detection processing unit 20 includes a storage unit an acquisition unit 22, a comparison unit 23, and an output unit 24. The storage unit 21 acquires information about each process from the OS 10 and stores information indicating the parent-child relationship between processes in a process database 30 in which information about each process is stored. Specifically, the storage unit 21 uses an application programming interface (API) for the OS 10 to acquire information about each process. The storage unit 21 then stores the acquired information in the process database 30.

The process database 30 is a database that manages information about each process. That is, the process database 30 is an example of a process storage unit.

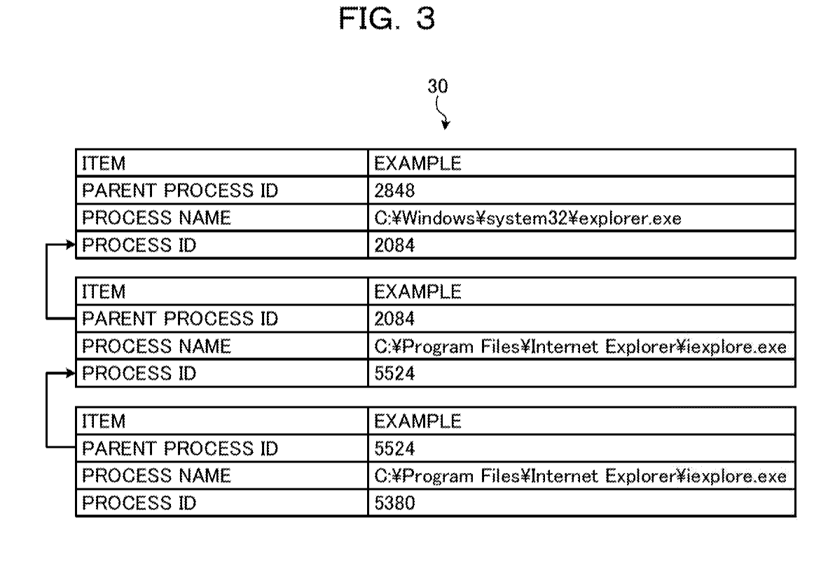

FIG. 3 is an illustrative diagram depicting an example of the process database 30. As illustrated in FIG. 3, the process database 30 stores therein, for each process, identification information identifying the process and the parent process to the process (a process ID and a parent process ID) as well as information about the process, such as a process name.

In the example in FIG. 3, for a process with a process ID of “5380”, the process ID of its parent process is “5524” and the process name, “iexplor.exe”, with the path is represented. Likewise, for a parent process with a process ID of “5524”, the process ID of the parent process of this parent process is “2084” and the process name, “iexplor.exe”, with the path is represented. In such a manner, information indicating the parent-child relationship between processes is stored in the process database 30.

The acquisition unit 22 acquires, based on information indicating the parent-child relationship between processes, the name of the parent process of a predetermined process and the name of the parent process of the parent process of the predetermined process are acquired from the process database 30. Specifically, the acquisition unit 22 follows the process ID of the parent process to each process by using the process database 30 to acquire the name of the parent process of the process and the name of the parent process of the parent process of the process.

The comparison unit 23 compares the >name of the parent process and the name of the parent process of the parent process acquired by the acquisition unit 22. The comparison unit 23 outputs a comparison result to the output unit 24.

When, as a result of comparison by the comparison unit 23, both of the name of the parent process and the name of the parent process of the parent process are a predetermined name such as “iexplor.exe”, the output unit 24 outputs an alert indicating an anomaly. Specifically, the output unit 24 outputs an alert (warning) stating, for example, that because a distinctive event (anomaly) in a process tree is detected, it is suspected that an attack by malware has occurred.

Examples of the alert output by the output unit 24 include a popup message and a balloon in the display unit 40. In addition, the output unit 24 may output an alert by transmitting mail to a predetermined address via a communication unit (not illustrated). In addition, the comparison unit 23 may output an alert as a record in a log file (not illustrated). The user is able to become aware of an attack of malware by verifying these outputs.

The display unit 40 performs output for display to a display or the like. For example, the display unit 40 displays an alert output from the process database 30 on a display or the like. Thereby, the user is able to verify the content of the alert.

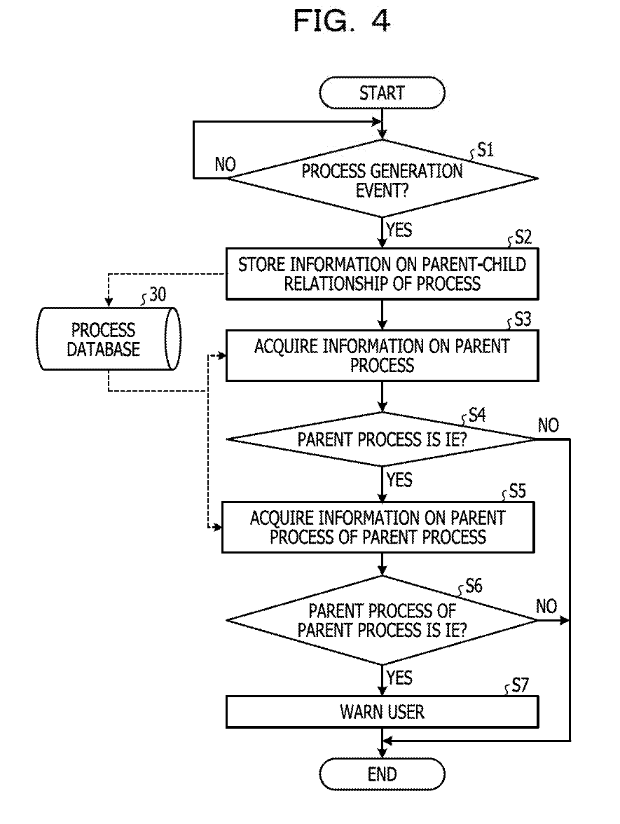

FIG. 4 is a flowchart illustrating an example of operations of the information processing apparatus 1 according to the embodiment. As illustrated in FIG. 4, as the process begins, the storage unit 21 monitors the presence or absence of a process generation event in the OS 10 via the API and determines whether a process is generated (S1). If a process generation event has not occurred and no process is generated (S1: No), the storage unit 21 waits for processing.

If a process is generated (S1: Yes), the storage unit 21 acquires information about the process by the OS 10 via the API and stores information on the parent-child relationship of the generated process in the process database 30 (S2). Subsequently, the acquisition unit 22 acquires information on the parent process of the generated process from the process database 30 (S3). Specifically, the acquisition unit 22 acquires, by using a process ID indicating the parent process of the generated process, the name of this parent process.

Subsequently, the comparison unit 23 determines whether the name of the parent process acquired in S3 is IE (iexplor.exe) (S4). If not IE (S4: No), the comparison unit 23 ends the process.

If IE (S4: Yes), the acquisition unit 22 acquires information on the parent process of the parent process of the generated process from the process database 30 (S5). Specifically, the acquisition unit 22 acquires the process ID of the parent process of the parent process by using the process ID indicating the parent process of the generated process. Subsequently, the acquisition unit 22 acquires the name of the parent process of the parent process by using the acquired process ID.

Subsequently, the comparison unit 23 determines whether the name of the parent process of the parent process acquired in S5 is IE (iexplor.exe) (S6). If not IF (S6: No), the comparison unit 23 ends the process.

If IE (S6: Yes), the output unit 24 outputs an alert (warning) stating, for example, that it is suspected that an attack by malware has occurred, through display of the alert by the display unit 40, or the like (S7).

As described above, the storage unit 21 of the information processing apparatus 1 stores information indicating a parent-child relationship between processes in the process database 30 in which information about each process is stored. The acquisition unit 22 of the information processing apparatus 1 acquires the name of the parent process of a predetermined process and the name of the parent process of the parent process of the predetermined process from the process database 30. The comparison unit 23 of the information processing apparatus 1 compares the name of the parent process and the name of the parent process of the parent process acquired by the acquisition unit 22. The output unit 24 of the information, processing apparatus 1 outputs an anomaly, which indicates an attack by malware, when, as a result of comparison by the comparison unit 23, both of the names of processes are a predetermined name. Thus, the information processing apparatus 1 is able to detect an anomaly even when, for example, through an attack approach such as a drive by download, unknown malware that is yet to be registered in virus definition databases and the like is downloaded and executed.

Note that each component of each device illustrated in the drawings may not be physically configured as strictly as illustrated in the drawings. That is, the specific forms of distribution and integration of the devices are not limited to those illustrated in the drawings, and all or some of the devices may be configured so as to be functionally or physically distributed and integrated in any units in accordance with various loads and usage situations.

In addition, various processing functions performed in the information processing apparatus 1 may be such that all or any part thereof are performed on a central processing unit (CPU) (or on a micro-computer such as a microprocessor unit (MPU) or a micro controller unit (MCU)). Furthermore, it is to be understood that various processing functions may be such that all or any part thereof may be executed on programs that are analyzed and executed by a CPU (or a microcomputer such as MPU or MCU) or on hardware using wired logic. Furthermore, various processing functions performed in the information processing apparatus 1 may be executed by a plurality of computers cooperating with each other in a cloud computing environment.

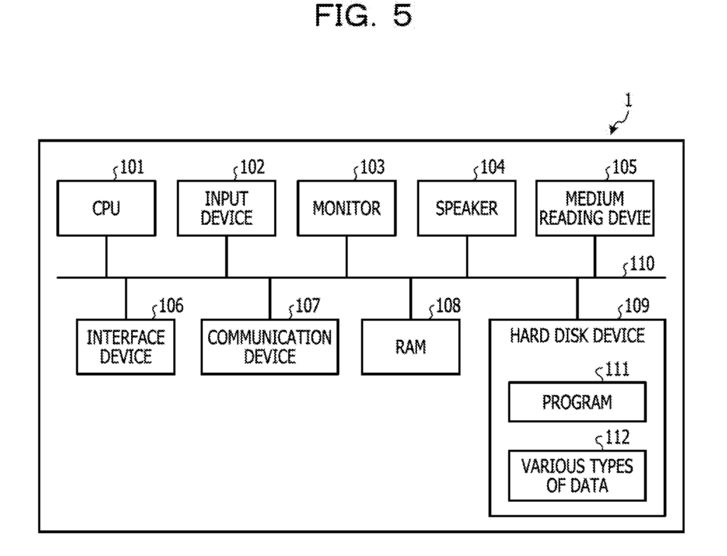

Various types of processing described in the foregoing embodiment are able to be implemented by a computer executing a program prepared in advance. An example of a computer (hardware) that executes a program having the same functions as the foregoing embodiment will be described below. FIG. 5 is a block diagram illustrating an example of a hardware configuration of the information processing apparatus 1 according to an embodiment.

As illustrated in FIG. 5, the information processing apparatus 1 includes a central processing unit (CPU) 101 that executes various types of arithmetic processing, an input device 102 that accepts data input, a monitor 103, and a speaker 104. The information processing apparatus 1 also includes a medium reading device 105 that reads a program or the like from a storage medium, an interface device 106 for coupling to various devices, and a communication device 107 for communicatively coupling, wired or wirelessly, to an external device. The information processing apparatus 1 also includes a random access memory (RAM) 108 that temporarily stores various types of information, and a hard disk device 109. In addition, each unit (101 to 109) in the information processing apparatus 1 is coupled to a bus 110.

In the hard disk device 109, a program 111 for performing various types of processing with the storage unit 21, the acquisition unit 22, the comparison unit 23, the output unit 24, and the like in the anomaly detection processing unit 20 described in the foregoing embodiment is stored. In addition, in the hard disk device 109, various types of data 112 that the program 111 references are stored. The input device 102, for example, accepts input of operation information from an operator of the information processing apparatus 1. The monitor 103, for example, displays various screens operated by an operator. To the interface device 106, for example, a printing device or the like is coupled. The communication device 107, which is coupled to a communication network such as a local area network (LAN), exchanges various types of information with an external device via the communication network.

The CPU 101 reads the program 111 stored in the hard disk device 109 and loads and executes the program 111 in the RAM 108, thereby performing various types of processing. Note that the program 111 may not be stored in the hard disk device 109. For example, the program 111 stored on a storage medium readable by the information processing apparatus 1 may be read and executed. To the storage medium readable by the information processing apparatus 1, for example, a portable recording medium such as a compact disc read-only memory (CD-ROM), a digital versatile disc (DVD), or a universal serial bus (USB) memory, a semiconductor memory such as a flash memory, a hard disk drive, or the like corresponds to. In addition, the program 111 may be stored in a device coupled to public lines, the Internet, a LAN, and the like, and the information processing apparatus 1 may read the program 111 through these lines and execute the program 111.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be uncle stood that the various changes, substitutions, and alterations could be made hereto without departing from the spirit and scope of the invention.

What is claimed is:

1. An anomaly detection method comprising:
obtaining information indicating a parent-child relationship of a process;
specifying a first name of a first parent process of the process and a second name of a second parent process of the first parent process on the basis of the information;
determining whether each of the first name of the first parent process and the second name of the second parent process includes specific name; and
outputting anomaly information in accordance with a result of the determining.

2. The anomaly detection method according to claim 1, wherein the obtaining is executed in response to generation of the process.

3. The anomaly detection method according to claim 1, wherein the specific name is relative to browser application.

4. The anomaly detection method according to claim 1, wherein the anomaly information indicates that the process is launched by malware.

5. The anomaly detection method according to claim 1, wherein the process is generated by the first parent process and the first parent process is generated by the second parent process.

6. An anomaly detection apparatus comprising:
circuitry configured to:
perform obtainment of information indicating a parent-child relationship of a process;
specify a first name of a first parent process of the process and a second name of a second parent process of the first parent process on the basis of the information;
determine whether each of the first name of the first parent process and the second name of the second parent process includes specific name; and
output anomaly information in accordance with a result of the determining.

7. The anomaly detection apparatus according to claim 6, wherein the obtainment is executed in response to generation of the process.

8. The anomaly detection apparatus according to claim 6, wherein the specific name is relative to browser application.

9. The anomaly detection apparatus according to claim 6, wherein the anomaly information indicates that the process is launched by malware.

10. The anomaly detection apparatus according to claim 6, wherein the process is generated by the first parent process and the first parent process is generated by the second parent process.

11. A non-transitory computer-readable medium storing an anomaly detection program that causes a computer to execute a process comprising:
obtaining information indicating a parent-child relationship of a process;
specifying a first name of a first parent process of the process and a second name of a second parent process of the first parent process on the basis of the information;
determining whether each of the first name of the first parent process and the second name of the second parent process includes specific name; and
outputting anomaly information in accordance with a result of the determining.

12. The medium according to claim 11, wherein the obtaining is executed in response to generation of the process.

13. The medium according to claim 11, wherein the specific name is relative to browser application.

14. The medium according to claim 11, wherein the anomaly information indicates that the process is launched by malware.

15. The medium according to claim 11, wherein the process is generated by the first parent process and the first parent process is generated by the second parent process.
